(19) United States
(12) Patent Application Publication
(10) Pub. No.: US 2014/0072278 A1
(43) Pub. Date: Mar. 13, 2014

(54) GPS/VIDEO DATA COMMUNICATION SYSTEM, DATA COMMUNICATION METHOD, AND DEVICE FOR USE IN A GPS/VIDEO DATA COMMUNICATION SYSTEM

(71) Applicants: Tobias Kramer, Feldkirchen (DE); Aleksandar Ristic, Munchen (DE)

(72) Inventors: Tobias Kramer, Feldkirchen (DE); Aleksandar Ristic, Munchen (DE)

(73) Assignee: GOBANDIT GMBH, Aschheim/Dornach (DE)

(21) Appl. No.: 13/145,416

(22) PCT Filed: Oct. 8, 2010
(86) PCT No.: PCT/EP2010/006170

§ 371 Date: Oct. 20, 2011

(30) Foreign Application Priority Data
Oct. 21, 2009 (DE) 10 2009 050 187.8

(51) Int. Cl. H04N 5/91

(52) U.S. Cl. CPC H04N 5/91
USPC 386/240

(57) ABSTRACT

The invention relates to a GPS and/or video data communication system, a data communication method, and devices for use in a GPS and/or video data communication system, in particular to a data communication method comprising the following steps: (a) providing image data (9; 19) recorded by a video camera (2); and (b) integrating additional image data (7a, 7b; 8; 15) into the image data recorded by the video camera (2). Alternatively or additionally, the data communication method can comprise the following step: integrating data obtained by a measuring device (4) or produced therefrom into the image data recorded by the video camera (2).

The invention relates to a GPS and/or video data communication system, a data communication method, and devices for use in a GPS and/or video data communication system.

In particular, the invention relates to a GPS and/or video data communication system, a data communication method, and devices for use in a GPS and/or video data communication system which can be used in combination with a video camera, as well as to GPS and/or video data communication systems, methods and devices which can comprise a video camera as a component thereof.

Video cameras are devices for recording images, in particular for recording moving images, and the constant conversion thereof into electric signals.

In the broader sense, also digital cameras can be called “video cameras”.

A microphone can be integrated in a video camera for the sound recording; alternatively or additionally, a video camera can comprise one or more connections to which corresponding microphones can be connected.

Alternatively or additionally, also a video recorder can be integrated in a video camera; such a video camera is generally called “camcorder”.

Furthermore, it is already known to integrate corresponding GPS receivers of GPS systems into video cameras.

GPS/global positioning systems are based e.g. on satellites which permanently transmit their current position and/or the exact time by means of encoded radio signals. From the signal propagation times (signal transit times) and/or from the time, GPS receivers can then compute e.g. their own position and/or speed (velocity).

Theoretically, the signals of three satellites are sufficient therefor, as therefrom the exact position and altitude of a GPS receiver can be determined.

In practice, however, GPS receivers generally do not comprise a clock which is precise enough in order to enable a measurement of the propagation times with sufficient accuracy. Therefore, the signal of a fourth satellite is required by means of which then the exact time can be determined in the GPS receiver.

Apart from the position, also the speed of a GPS receiver and/or its direction of movement, etc., can be determined by means of GPS signals.

Furthermore, in many video cameras a display is provided by means of which the recorded moving images/videos can be viewed.

For the recording of action scenes—for instance during skiing, snowboarding, bicycling, in particular mountain biking, surfing, waterskiing, driving a motor boat, sailing, driving a car, motorcycling, etc., etc.—video cameras are used which are as small and as light as possible.

Very often, such video cameras are not held in hand during the recording, but are for instance fastened to a helmet, to the clothing, etc.

More and more frequently, moving images/videos recorded by a video camera are put on the Internet, e.g. at Internet platforms such as Youtube® (http://www.youtube.com), etc.

Consequently, many users of video cameras want to edit the recorded moving images/videos as “spectacular” as possible in a simple manner.

The object of the invention is to provide a novel GPS and/or video data communication system, a novel data communication method as well as novel devices for use in a GPS and/or video data communication system.

The invention achieves said object and/or further objects by means of the subject matters of the independent claims. Advantageous further developments of the invention are set forth in the subclaims.

According to one aspect of the invention, a data communication method is provided which comprises the following steps: (a) providing image data recorded by a video camera, and (b) integrating additional image data into the image data recorded by the video camera.

Alternatively or additionally, the data communication method can for instance comprise the following step: integrating data obtained by a measuring device, for instance a GPS receiver, or produced therefrom into the image data recorded by the video camera.

Advantageously, the measuring device is a GPS receiver or comprises a GPS receiver.

Advantageously, the measuring device is a speed or acceleration measuring device and/or a temperature measuring device and/or a time measuring device and/or a heart rate measuring device and/or a barometric altitude measuring device, or comprises such a device.

Advantageously, the additional image data are stored beforehand in a computer and/or server.

Advantageously, the additional image data are allocated to one of several predetermined categories.

Advantageously, the one of several predetermined categories is the category skiing, and/or snowboarding, and/or bicycling, in particular mountain biking, and/or surfing, and/or water skiing, and/or driving a motor boat, and/or sailing, and/or driving a car, and/or motorcycling, and/or flying, and/or parachuting, and/or paragliding, and/or hang-gliding.

In accordance with a further aspect of the invention, a GPS and/or video data communication system is provided which comprises:
a device for the integration of additional image data into image data recorded by a video camera.

Advantageously, the device comprises a computer and/or a server.

Advantageously, the GPS and/or video data communication system additionally comprises a device for the integration of data obtained by a measuring device or produced therefrom into the image data recorded by the video camera.

Advantageously, the device for the integration of data obtained by the measuring device or produced therefrom is a computer and/or a server or comprises such a computer and/or a server.

The invention will now be explained in more detail by means of several embodiments as well as the accompanying drawings, in which:

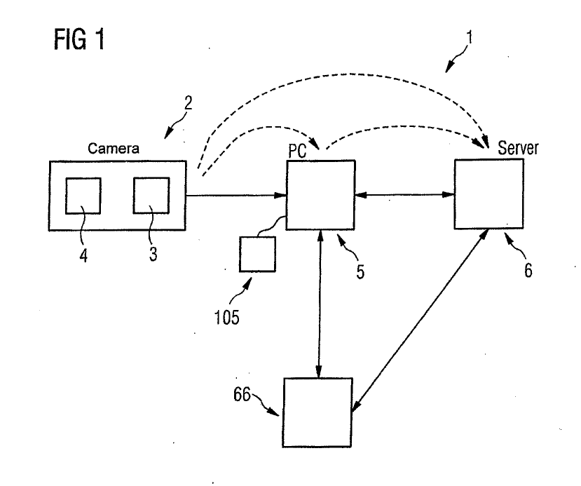

FIG. 1 is a diagrammatic exemplary representation of a GPS and/or video data communication system according to an embodiment of the present invention;

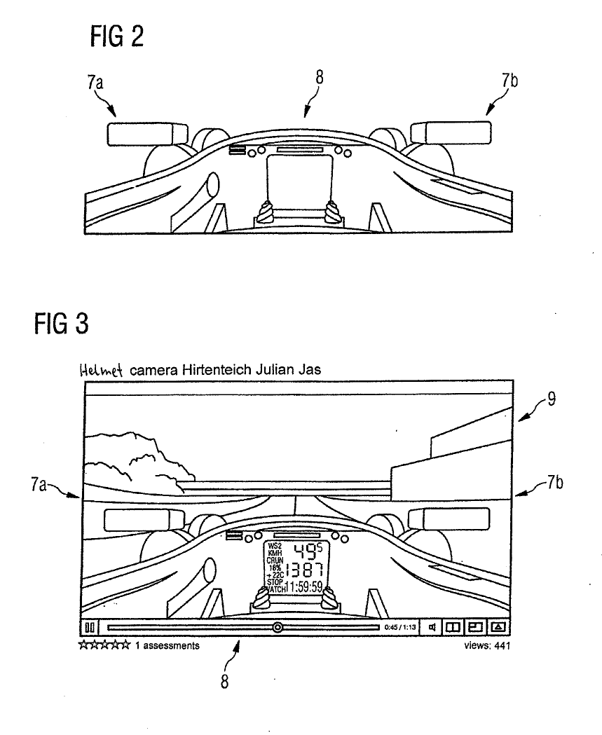

FIG. 2 is an exemplary representation of additional image data/“skin” image data which can be used in the data communication system for the editing of recorded video image data;

FIG. 3 is an exemplary representation of data displayed after the integration of additional image data/“skin” image data into video image data recorded during driving a car;

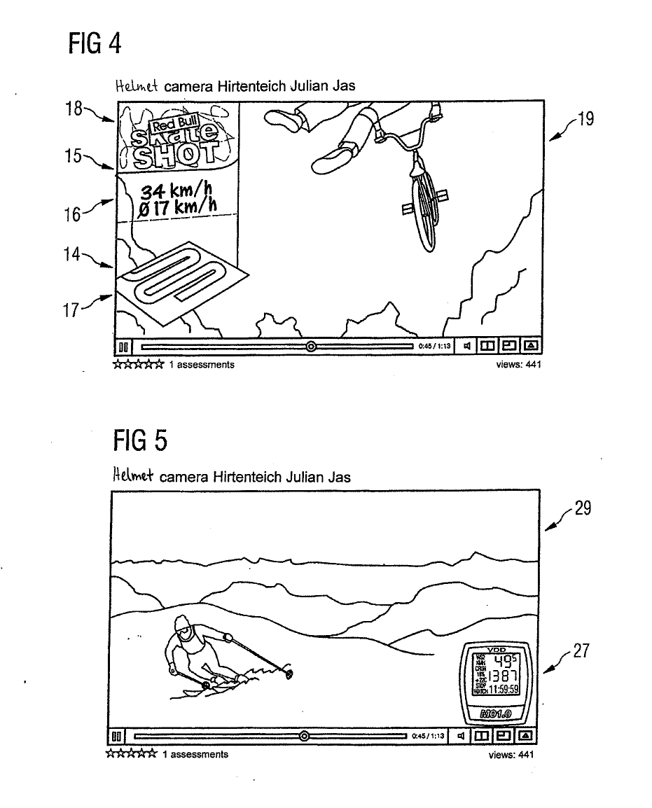

FIG. 4 is an exemplary representation of data displayed after the integration of additional image data/“skin” image data into video image data recorded during bicycling;

FIG. 5 is an exemplary representation of data displayed after the integration of additional image data/“skin” image data into video image data recorded during skiing;

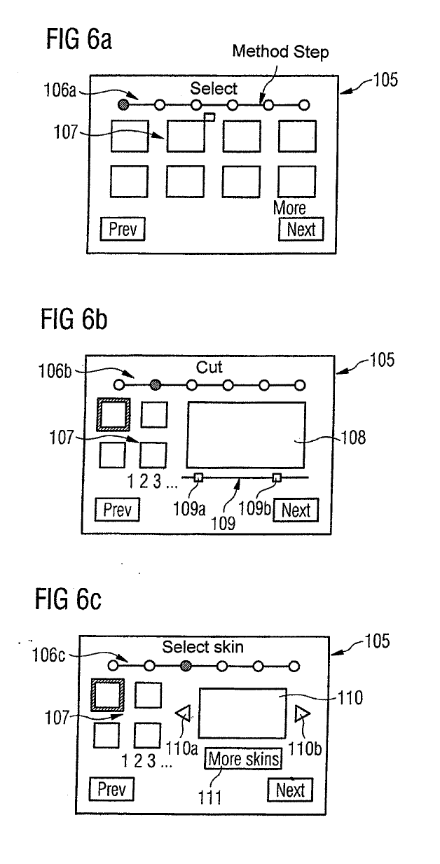

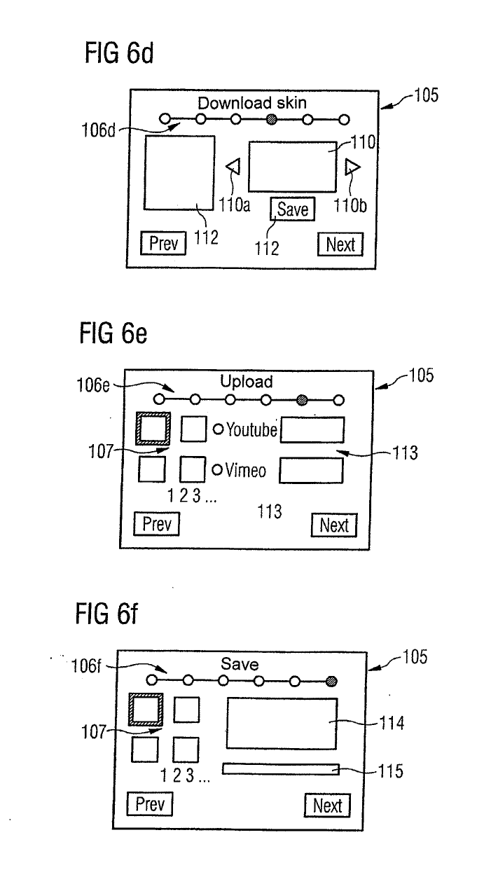

FIG. 6a-6f are exemplary representations of data respectively displayed on a display device of a computer of a user, for the explanation of method steps exemplarily carried out during the editing of recorded video image data.

In FIG. 1 there is diagrammatically shown an exemplary representation of a GPS and/or video data communication system 1 according to an embodiment of the present invention.

The system 1 comprises a video camera or digital camera 2.

The video camera 2 can comprise a display by means of which the moving images/videos recorded by the video camera can be viewed during and/or after the recording. Alternatively, also a video camera without a display can be used—for instance in order to keep the dimensions of the camera small. In a further variant, also an external display can be used which is connected with the video camera 2 in a wire-bound manner or in a wireless manner (e.g. via Bluetooth).

By means of the video camera 2, images, in particular moving images, can be recorded.

Advantageously, the video camera 2 is a camcorder, i.e., the recorded image data can be saved in analog or—preferably—digital form in the video camera 2.

Advantageously, prior to the storage, a compression of the image data takes place, for instance by using a JPEG or MPEG video data compression method, in particular e.g. a H.264/H.263/H.262 video data compression method, or by using any other compression method, in particular a method which conforms to a corresponding standard.

Then the image data will be saved e.g. in the format corresponding to the respective compression method or in the format defined in the respective standard.

For the storage of the (compressed) image data there can be used for instance a magnetic tape or—particularly advantageously—a digital storage medium 3, for instance a (rewriteable) DVD, an integrated hard disk (drive), an exchangeable micro drive, or—in general entirely without any movable parts—a memory card, in particular a flash memory card, for instance an SD or “secure digital” memory card, in particular for instance a micro SD memory card (or any other memory card, e.g. an XDCAM, SxS, DVCPro, P2 memory card, etc.).

The video camera 2 can be supplied with power from a battery or an accumulator.

For the sound recording, a microphone can be integrated in the video camera 2; alternatively or additionally, the video camera 2 can comprise one or several connections to which corresponding microphones can be connected. The connection of a microphone to the video camera 2 can be effected in a wire-bound manner or—particularly advantageously—in a wireless manner, which, in particular, can have e.g. the advantage that wind noises can be avoided or reduced.

The recorded sound data can be stored in the video camera 2 in analog or—preferably—digital form.

Advantageously, a compression can also be carried out prior to the storing of the sound data.

For the storing of the (compressed) sound data there can be used for instance the above-mentioned magnetic tape or—which is particularly advantageous—the above-mentioned digital storage medium 3, in particular the above-mentioned SD memory card (or a separate analog or digital storage medium).

As an alternative, there can also be used a video camera 2 without any microphone or without any microphone connections, for instance in order to keep the dimensions of the camera small.

For instance, the video camera 2 can be a shoulder camera, i.e. a camera which is carried on the shoulder, or—advantageously—a hand-held camera which is held in front of the body.

When a shoulder camera is used as the video camera 2, the camera can have a shaping at the bottom side thereof for the support on the shoulder and can have a corresponding center of gravity which lies on the shoulder; then the view finder can be mounted laterally at the camera.

When a hand-held camera is used as the video camera 2, the view finder can be positioned at the rear end of the camera.

It is particularly advantageous when a camera is used as the video camera 2 which is provided for or which is suitable for the recording of action scenes—for instance during skiing, snowboarding, bicycling, in particular mountain biking, surfing, waterskiing, driving a motor boat, sailing, driving a car, motorcycling, flying, parachuting, paragliding, hang-gliding, etc., etc.

Advantageously, the video camera 2 has relatively small dimensions, for instance a length of less than 18 cm or 14 cm, in particular less than 8 cm, and/or a height and/or a width of less than 7 cm or 5 cm, in particular less than 3 cm.

Very often such—small—video cameras are not held in hand during recording, but are fastened for instance to a helmet (“helmet camera”) or for instance to the clothing (e.g. to the jacket, to the shirt, to the pullover or sweater, to the T-shirt, to the cap), to the body (e.g. on an arm, in particular the upper arm, at the throat, on the chest, on the head), etc.

Alternatively, the video camera 2 can also be attached to a sports equipment, for instance a ski, a snowboard, a ski or snowboard stick, a bicycle, in particular a mountain bike, a surfboard, a water ski, a motor boat, a sailing boat or to a vehicle, e.g. a motorcar (car), a motorcycle, or e.g. to an aircraft, a parachute, a paraglider, a hang-glider, balloon, etc.

Advantageously, the video camera 2 is waterproof.

At the video camera 2, the beginning and/or the end of the recording of image and/or sound data can be triggered manually and/or—at least partially—also automatically, e.g. upon exceeding or falling below a certain speed, upon entering or exiting a certain area (e.g. determined by means of GPS), upon exceeding or falling below a certain altitude, upon exceeding or falling below a certain heart rate, etc., etc.

A GPS receiver 4 of a GPS system can be integrated in the video camera 2, as is shown in FIG. 1.

The GPS receiver 4 can communicate with satellites of a GPS/global positioning system which, by means of encoded radio signals, permanently transmit their current position and/or the exact time. Then, from the signal propagation times or from the time, the GPS receiver 4 can compute its position and/or altitude (in particular the altitude above sea level) and/or its speed, and/or its direction of movement—and, thus, the position or altitude of the video camera 2 or the speed or the direction of movement thereof.

Instead of a GPS receiver 4 internally integrated into the video recorder 2, also an external GPS receiver can be used which can be connected to the video camera 2 via one or several video camera connections.

Alternatively, there can also be used a video camera 2 without any GPS receiver or without any GPS receiver connections.

Alternatively or additionally, a speed or acceleration measuring device can be integrated in the video camera 2, and/or a speed or acceleration measuring device can be connected to the video camera 2.

Furthermore, alternatively or additionally, a time measuring device can be integrated in the video camera 2, and/or a time measuring device can be connected to the video camera 2.

Also, alternatively or additionally, a temperature measuring device can be integrated in the video camera 2, and/or a temperature measuring device can be connected to the video camera 2.

Moreover, alternatively or additionally, a heart rate measuring device can be integrated in the video camera 2, and/or a heart rate measuring device can be connected to the video camera 2.

Furthermore, alternatively or additionally, a barometric altitude measuring device can be integrated in the video camera 2, and/or a barometric altitude measuring device can be connected to the video camera 2, and/or a compass, in particular an electronic compass, can be integrated in the video camera 2 and/or can be connected thereto, etc.

The connection of the above-mentioned (external) GPS receiver 4, and/or of the above-mentioned (external) speed or acceleration measuring device, and/or of the above-mentioned (external) temperature measuring device, and/or of the above-mentioned (external) time measuring device, and/or of the above-mentioned further (external) measuring devices to the video camera 2 can be carried in a wire-bound manner or in a wireless manner, e.g. by means of Bluetooth, WiFi, etc.

In a further variant, the video camera 2 can, for instance, also comprise a further interface, e.g. a CAN bus interface, by means of which the video camera 2 can be connected for instance to a motor vehicle, in particular a motorcar, a motorcycle, etc., particularly to a bus system provided therein, for instance a CAN bus system, and, thus, to further measuring devices provided therein or to control devices or memory devices storing data (speed or number of revolutions, temperature of the vehicle, outside temperature, engine temperature, vehicle speed, momentary performance, etc., etc.) provided by said measuring devices.

The video camera 2 can comprise a display by means of which also the data provided by the GPS receiver 4, and/or the speed or acceleration measuring device, and/or the temperature measuring device, and/or the time measuring device, and/or the above-mentioned further measuring devices, can be displayed in addition to the moving images/videos recorded by the video camera during or after their recording.

Alternatively, for instance in order to keep the dimensions of the camera small, also a display can be used with which the data provided by the GPS receiver 4, and/or the speed or acceleration measuring device, and/or the temperature measuring device, and/or the time measuring device, and/or the above-mentioned further measuring devices, are displayed, but not the moving images/videos recorded by the video camera 2.

For the storage of the data provided by the GPS receiver 4, and/or the speed or acceleration measuring device, and/or the temperature measuring device, and/or the time measuring device, and/or the above-mentioned further measuring devices, for instance the above-mentioned magnetic tape or—which is particularly advantageous—the above-mentioned digital storage medium 3, in particular the above-mentioned SD card, can be used.

In this connection, the data provided by the GPS receiver 4, and/or the speed or acceleration measuring device, and/or the temperature measuring device, and/or the time measuring device, and/or the above-mentioned further measuring devices, can be stored in an own file on the magnetic tape or on the digital storage medium 3 (and the above-mentioned (compressed) image data can be stored in a file which is separate therefrom).

For the storage of the data provided by the GPS receiver 4, and/or the speed or acceleration measuring device, and/or the temperature measuring device, and/or the time measuring device, and/or the above-mentioned further measuring devices, there can be used another data format than for the storage of the (compressed) image data.

Alternatively, the data, or parts thereof, provided by the GPS receiver 4, and/or the speed or acceleration measuring device, and/or the temperature measuring device, and/or the time measuring device, and/or the above-mentioned further measuring devices, can also be stored in a form integrated into the above-mentioned (compressed) image data.

For this purpose, in the video camera 2 a multiplexer can be used which is realized therein for instance by software and/or hardware (e.g. by using a corresponding microprocessor).

The image data and the above-mentioned data, or parts thereof, provided by the GPS receiver 4, and/or the speed or acceleration measuring device, and/or the temperature measuring device, and/or the time measuring device, and/or the above-mentioned further measuring devices, can be stored by the multiplexer for instance in one and the same file on the magnetic tape or on the digital storage medium 3.

The data, or parts thereof, provided by the GPS receiver 4, and/or the speed or acceleration measuring device, and/or the temperature measuring device, and/or the time measuring device, and/or the above-mentioned further measuring devices, can then for instance be stored in a data format which corresponds to the (standard) data format used for the storage of the image data.

Then the corresponding data provided by the GPS receiver 4, and/or the speed or acceleration measuring device, and/or the temperature measuring device, and/or the time measuring device, and/or by the above-mentioned further measuring devices will be shown as additional data overlaid or inserted into the image data when the image data are viewed e.g. on the above-mentioned display.

Alternatively or additionally, the corresponding data provided by the GPS receiver 4, and/or the speed or acceleration measuring device, and/or the temperature measuring device, and/or the time measuring device, and/or the above-mentioned further measuring devices, can also be stored for instance in an on-modulated manner in the sound track or in the subtitle image track of the above-mentioned magnetic tape, or in other digital data records of the digital storage medium 3 intended for the storage of sound data belonging to the above-mentioned image data (if necessary, also once again after a corresponding modulation).

Alternatively or additionally, the data, or parts thereof, provided by the GPS receiver 4, and/or the speed or acceleration measuring device, and/or the temperature measuring device, and/or the time measuring device, and/or the above-mentioned further measuring devices, can also be saved in a separate analog or digital storage medium instead of in the above-mentioned analog or digital storage medium 3 in which the above-mentioned image data are stored.

In all above-mentioned variants, the above-mentioned image data and/or the data provided by the GPS receiver 4, and/or the speed or acceleration measuring device, and/or the temperature measuring device, and/or the above-mentioned further measuring devices can be stored with a “time stamp”, respectively, i.e. together with data—for instance provided by the time measuring device or the GPS receiver—which indicate at what time and/or on what day and/or in which month and/or in which year the data were recorded or measured or computed.

In one variant of the invention, a further video camera, which can be constructed correspondingly similar or identical to the video camera 2, can be used in addition—and in parallel—to the video camera 2.

The further video camera can record corresponding further image data—at least in part in parallel or at the same time as the video camera 2.

By way of example, both video cameras can be fastened in a substantially parallel orientation to the helmet of the user (e.g. the video camera 2 on the right side and the further video camera on the left side of the helmet), or can be fastened to the clothing, or to the body, or to the sports equipment of the user in a substantially parallel orientation (e.g. on the left and right upper arm, on the left and right side of the bicycle handle bar, etc., etc.).

Then, for instance, both video cameras can substantially cover identical angles of view or angles of view overlapping each other to a high degree (for instance, both video cameras cam film towards the front).

Then, from the image data recorded by the video camera 2 in combination with the further image data recorded by the further video camera there can be obtained corresponding 3D image data.

Alternatively, the two video cameras can also cover completely different angles of view or angles of view overlapping each other only to a small degree (e.g. the video camera 2 can film towards the front side and the further video camera can film towards the left or right side or towards the rear side, etc.).

The further video camera can be autarkic; the further image data recorded by the further video camera 2 can be stored therein in a corresponding analog or digital storage medium, in a manner as described above with reference to the video camera 2.

Alternatively or additionally, the further video camera can be connected with video camera 2 in a wire-bound or wireless manner; the further image data recorded by the further video camera can then be transferred to the video camera 2 and can be stored on the analog or digital storage medium of the video camera 2 (for instance in the form of corresponding 3D image data) in particular in addition to the image data recorded by the video camera 2.

As is illustrated in FIG. 1, in the data communication system 1 the data (or parts thereof) stored on the above-mentioned analog or digital storage medium 3 and/or on the above-mentioned separate (additional) analog or digital storage medium of the video camera 2 and/or of the further video camera can be transferred to a computer 5 allocated to the user of the video camera 2 or of the further video camera, for instance the user's PC (personal computer)/notebook/laptop/netbook/telephone or mobile phone with computer functions, etc.

The transmission of the data to the computer 5 of the user can be carried out in a wire-bound manner, for instance by means of a respective USB interface, or in a wireless manner.

Alternatively or additionally, also a wireless transmission of the data to the computer 5 is possible, for instance by means of a corresponding Bluetooth interface or a WiFi interface or via GSM/GPRS/UMTS/3G, or in any other manner.

The transmission of the data to the computer 5 can be triggered “manually” or also automatically, for instance when the video camera 2 reaches the transmission area of a public WiFi hotspot or the transmission area of a private radio network in the house of the user of the video camera 2, or in any other manner.

Alternatively or additionally, as is illustrated in FIG. 1 by means of corresponding dashed lines, in the data communication system 1 the data (or parts thereof) stored on the above-mentioned analog or digital storage medium 3 and/or on the above-mentioned separate (additional) analog or digital storage medium of the video camera 2 or of the further video camera can be transferred to a central server 6 which is shared by a plurality of users of a plurality of video cameras. The central server 6 can for instance be shared by more than 100 users of more than 100 video cameras, or by even a greater number of users of an even greater number of video cameras (e.g. by more than 1,000 or more than 10,000 users).

The transmission of the data to the central server 6 can be carried out in a wire-bound manner and/or in a wireless manner, and with or without an interconnection of the computer 5 (PCs/notebooks/laptops/netbooks/telephones or mobile phones with computer functions, etc.) of the user and/or of one or more further computers, e.g. corresponding routers (e.g. by means of a corresponding USB or Bluetooth interface to the computer 5 and then via the Internet to the central server 6, or by means of WiFi via a corresponding WiFi router, or by means of GSM/GPRS/UMTS/3G directly from the video camera 2 to the central server 6, or in any other manner).

The transmission of the data to the central server 6 can be triggered “manually” or also automatically, e.g. when the video camera 2 reaches the transmission area of a public WiFi hotspot or the transmission area of a private radio network in the house of the user of the video camera 2, or in any other manner.

Alternatively or additionally, and with or without a previous storage on the above-mentioned analog or digital storage medium 3 and/or on the above-mentioned separate (additional) analog or digital storage medium of the video camera 2 (or completely without any storage at all on the above-mentioned storage media), the above-mentioned data (or parts thereof) can be transmitted not just in a time-delayed manner, for instance more than 10 minutes or more than 1 hour, etc., after the recording/measurement of the respective data, but directly during or after the recording of the data—quasi “live”—to the above-mentioned computer 5 or to the above-mentioned central server 6 (in particular less than 1 minute, for instance less than 10 or 2 seconds, after the recording/measuring of the data) (“live streaming”). This can take place for instance in a wireless manner, e.g. by means of GSM/GPRS/UMTS/3G, and/or by means of a corresponding Bluetooth or WiFi interface, or in any other manner.

By means of the above-mentioned wireless connection of the video camera 2 (GSM/GPRS/UMTS/3G, etc.) there is rendered possible not only a corresponding streaming, in particular the above-mentioned live streaming, of data to the computer 5/the central server 6, but also a corresponding download of data onto the video camera 2.

Advantageously, the above-mentioned live streaming of the above-mentioned data (or of parts thereof) to the above-mentioned computer 5 or the above-mentioned central server 6 is carried out with a lower data resolution than the storing of the above-mentioned data (or of parts thereof) on the above-mentioned analog or digital storage medium 3 and/or on the above-mentioned separate (additional) analog or digital storage medium of the video camera 2.

In an advantageous variant, the data transmitted by means of live streaming to the computer 5 or to the central server 6 can be displayed directly in the Twitter account of the user; or, as in such a Twitter account generally only text data, e.g. a maximum of 140 characters, can be displayed, in the respective Twitter account there can be indicated only an indication that there are provided new video image data for the respective user (which can be viewed also by other users), and/or an indication to the link/the data path where exactly said video image data can be retrieved, etc.

The above-mentioned text indication data displayed in the Twitter account (e.g. “new video with a maximum speed of 145 km/h during skiing in Hintertux: www.youtube.com/GHFRF”) can be displayed in the Twitter account allocated to the user for instance automatically before, during or after the beginning of the above-mentioned live streaming, i.e. a corresponding Twitter update can be carried out automatically in the respective Twitter account.

The text indication data can contain corresponding data provided by or obtained from the GPS receiver 4, and/or the speed or acceleration measuring device, and/or the temperature measuring device, and/or the time measuring device, and/or the above-mentioned further measuring devices.

The transmission of the above-mentioned data (or of parts thereof) to the computer 5 or to the central server 6 can also be carried out by way of interconnection of a mobile phone, in particular the mobile phone of the user of the video camera 2.

As an example, the above-mentioned data can be transmitted from the video camera 2 to the above-mentioned mobile phone in a wireless or wire-bound manner, in particular by means of a corresponding Bluetooth interface.

The mobile phone can be held by the user for instance in his/her hand, or the mobile phone can be positioned in a pocket or bag of the user, or it can for instance be fastened to the helmet or to the clothing or to the body or to the respective sports equipment, etc., in a manner similar to the one described above with respect to the video camera.

The display of the mobile phone can then function as a view finder for the video camera 2 displaying the recorded image data quasi “live”; alternatively or additionally, on the display of the mobile phone there can also be displayed—with a correspondingly freely selectable time delay—the above-mentioned data (or parts thereof) stored on the above-mentioned analog or digital storage medium 3 and/or on the above-mentioned separate (additional) analog or digital storage medium of the video camera 2, if necessary after a previous storage of said data in the mobile phone (see below).

Alternatively or additionally, the above-mentioned functions can also be fulfilled by the above-mentioned (integrated) display of the video camera 2 or by the above-mentioned external video camera display:

Also these displays can for instance function as a view finder and can display there the image data recorded by the video camera 2 quasi “live”.

Alternatively or additionally, on the above-mentioned integrated or external video camera display also the above-mentioned data (or parts thereof) stored on the above-mentioned analog or digital storage medium 3 and/or on the above-mentioned separate (additional) analog or digital storage medium of the video camera 2 can be displayed—with a correspondingly freely selectable time delay.

In a further advantageous variant, the above-mentioned mobile phone and/or the above-mentioned (external or integrated) video camera display can also fulfil the function of a (remote) control device or can be used as a part of a (remote) control device. For instance, on the display of the mobile phone or on the above-mentioned (external or integrated) video camera display there can be displayed control elements such as “Start”, “Stop”, “Pause”, etc., for starting, stopping or interrupting the recording of image data by the video camera 2.

Alternatively or additionally, the video camera 2 can also be provided with a functional unit for voice recognition, or such a unit can be connected to the video camera 2 as an external operating element. The (external or integrated) functional voice recognition unit can fulfil a corresponding remote control function so that the recording of image data by the video camera 2 can be correspondingly started, stopped or interrupted by means of corresponding acoustic signals of the user, as for instance by the commands “Start”, “Stop”, or “Pause” articulated by the user.

Advantageously, by means of the above-mentioned (remote) control device (e.g. at least partially provided by the mobile phone, and/or the above-mentioned external or integrated video camera display, and/or the functional voice recognition unit, etc.) there can also be controlled a zoom function of the video camera 2, etc.

Instead of an intentional control “by hand” or per voice input by the respective user of the video camera 2, one or more of the above-mentioned functions (start, stop, pause, zoom, etc.) can also be controlled automatically.

The zoom can, for instance, be changed—automatically—in dependence on the respective speed. In particular, the zoom can be gradually decreased or increased when corresponding speed limits are exceeded; alternatively, the zoom can also be adjusted in an infinitely variable manner (the higher the speed, the lower or higher the zoom and, thus, the respective “field of view”).

Furthermore, the (external) display and/or the mobile phone can also comprise an analog/digital output for the connection of a monitor, a TV set, etc.

On the computer 5 (or on the central server 6) there is loaded a special software by means of which the user can edit the data (i.e. the above-mentioned (video) image data and/or the data provided by the GPS receiver 4, and/or the speed or acceleration measuring device, and/or the temperature measuring device, and/or the above-mentioned further measuring devices, etc.) transmitted to the computer 5 (or alternatively to the central server 6) in a particular way.

Actually, one or more sets of additional image data (“skin” image data)—in particular corresponding moving image data or still image data—can be stored beforehand on the computer 5 (and/or on the central server 6), which will be explained in more detail in the following.

One or more of the sets of “skin” image data stored on the computer 5 or on the central server 6 can be subjected to an updating at regular or irregular intervals (e.g. triggered by a change/update of the above-mentioned special software stored on the central server 6, or triggered by a change of the data accessed by said software, or in any other manner).

Thereby, for instance banners, logos or other elements, etc., contained in a set of “skin” image data can be changed or adapted or added or removed correspondingly. In other words, a dynamic change of the sets of “skin” image data can be carried out.

Advantageously, identical sets of “skin” image data can be used respectively—at least partially—for a plurality of different users or computers (which, as regards their functions, correspond to the computer 5).

A part of the elements of a set of “skin” image data can, however, also be generated user-individually and can be stored on the computer 5 of the respective user (and/or on the central server 6 by allocation to the respective user)—in other words, the above-mentioned sets of “skin” image data for different users will then differ from each other with respect to the user-individually generated elements (and will, otherwise, be identical).

By means of the user-individually generated elements there can for instance be indicated the rank or status of a user in his/her Internet community, his/her successes (e.g. the highest speed ever achieved by him/her, the highest altitude ever reached by him/her, etc.) and so on.

From the one or several sets of additional image data stored on the computer 5 or on the central server 6, the user can select that set of additional image data (“skin” image data) which is respectively desired for the data to be edited respectively, in particular (video) image data, etc.

A first one (and, if required, further ones) of the above-mentioned sets of additional image data is for instance provided for the editing of data with (video) image data recorded by the video camera 2 during driving a car (see for instance the additional image data/“skin” image data shown exemplarily in FIG. 2).

A second one (and, if required, further ones) of the above-mentioned sets of additional image data is for instance provided for the editing of data with (video) image data recorded by the video camera 2 during skiing.

A third one (and, if required, further ones) of the above-mentioned sets of additional image data is for instance provided for the editing of data with (video) image data recorded by the video camera 2 during mountain biking.

A fourth one (and, if required, further ones) of the above-mentioned sets of additional image data is for instance provided for the editing of data with (video) image data recorded by the video camera 2 during motorcycling, etc., etc.

In other words, for the editing of (video) image data recorded during a plurality of different kinds of activities/sports—e.g. skiing, snowboarding, bicycling, in particular mountain biking, surfing, waterskiing, driving a motor boat, sailing, driving a car, motorcycling, flying, parachuting, paragliding, hang-gliding, etc.—there can be stored beforehand one or more sets of different additional image data (“skin” image data), respectively, for each kind of activity/kind of sport on the computer 5 and/or the central server 6.

As becomes obvious from the exemplary representation of FIG. 2, the set of additional image data/“skin” image data shown therein relates to an (interior) view of a car/racing car from the point of view of a driver looking to the front (there are to be seen for instance the outside mirrors 7a, 7b as well as for instance the instrument panel 8 with metering or indicating devices, e.g. speedometer—but without any values indicated by the metering or indicating devices—, etc.).

Thus, the set of additional image data/“skin” image data shown in FIG. 2 is for instance well suited for the editing of (video) image data recorded during driving a car.

After the selection of the respectively desired set of additional image data/“skin” image data” by the user for the editing of the respective data, said additional image data/“skin” image data are integrated into the (video) image data contained in the data to be edited, respectively, by the computer 5 or the central server 6 and stored (for instance on the computer 5 or in a storage device allocated thereto, or on the central server 6 or in a storage device allocated thereto).

For this purpose, a multiplex device can be used which is realized in the computer 5 or in the central server 6 for instance by means of software.

Then, when viewing the (video) image data recorded by the video camera 2, the corresponding additional image data (“skin” image data) will appear as additional image data synchronously inserted in the (video) image data.

Alternatively or additionally, and in addition to or instead of the above-mentioned additional image data (“skin” image data), by the computer 5 or the central server 6 the data or parts thereof provided by the GPS receiver 4, and/or the speed or acceleration measuring device, and/or the temperature measuring device, and/or the time measuring device, and/or by the above-mentioned further measuring devices can be integrated into the (video) image data and can be saved (for instance on the computer 5 or in a storage device allocated thereto, or on the server 6 or in a storage device allocated thereto).

For this purpose, (also) the multiplex device realized in the computer 5 or the central server 6 for instance by means of software can be used.

The data provided by the GPS receiver 4, and/or the speed or acceleration measuring device, and/or the temperature measuring device, and/or the time measuring device, and/or the above-mentioned further measuring devices can then be stored in the computer 5 or in the central server 6 in a data format which corresponds to the (standard) data format used for the storage of the (video) image data and/or of the additional image data (“skin” image data).

Then, when the (video) image data recorded by the video camera 4 are viewed, the corresponding data provided by the GPS receiver 4, and/or the speed or acceleration measuring device, and/or the temperature measuring device, and/or the time measuring device, and/or the above-mentioned further measuring devices and/or the above-mentioned additional image data (“skin” image data) will appear as additional data synchronously inserted into the (video) image data.

When, for instance, the set of additional image data/“skin” image data shown in FIG. 2 is used for the editing of (video) image data recorded during driving a car, additional data will be inserted into the (video) image data 9 recorded by the video camera 2 during driving the car (see for instance the recording of a road, a road verge, or of the sky, etc., as shown in FIG. 3) which relate to the (interior) view of a car/racing car from the point of view of a driver looking to the front (see for instance the outside mirrors 7a, 7b as well as for instance the instrument panel 8 with metering and indicating devices, e.g. speedometer, etc., as shown in FIG. 3).

As will also become obvious from FIG. 3, here, advantageously, the data provided by the GPS receiver 4, and/or the speed or acceleration measuring device, and/or the temperature measuring device, and/or the time measuring device, and/or the above-mentioned further measuring devices can be represented for instance in such a manner as if they would be indicated by the metering or indicating devices, e.g. speedometer, etc., contained in the above-mentioned additional image data/“skin” image data.

As a further example, in FIG. 4 there is shown an exemplary representation of data displayed after the integration of additional image data/“skin” image data into video image data recorded during bicycling.

As becomes obvious from FIG. 4, additional data will be integrated into the (video) image data 19, recorded by the video camera 2 during bicycling, with the aid of a corresponding set of “skin” image data, said additional data representing for instance the distance 17 ridden on the bicycle/the course 17 ridden on the bicycle, as well as a commercial 18.

As becomes also obvious from FIG. 4, into the recorded (video) image data there will be additionally integrated the speed data 15 provided by the above-mentioned GPS receiver 4 and/or the speed or acceleration measuring device, and/or time data (not shown here) provided by the time measuring device, as well as data regarding the average speed 16 and/or regarding the lap time, calculated therefrom for instance by the GPS receiver 4 and/or by the speed or acceleration measuring device and/or by the video camera 2 and/or by the computer 5 and/or by the server 6, etc., etc.

The lap time can for instance be computed by defining for instance a corresponding starting and/or finishing line, for instance by means of corresponding GPS web points, etc., after or already during the recording of the image data by means of the video camera 2, or in any other manner.

Furthermore, position data 14 (for instance calculated from the data provided by the above-mentioned GPS receiver 4) will be integrated into the recorded (video) image data which indicate where exactly the bicycle is located at the moment (during a certain ride) on the distance 17 ridden/in the course 17.

Alternatively or additionally, further position data (calculated for instance from further data provided by the above-mentioned GPS receiver 4) can be integrated into the recorded (video) image data which will indicate where exactly the bicycle is located—during another, later or earlier ride—on the distance 17 ridden/in the course 17.

Thereby, a user can compare two different rides performed by him/her through the same course 17 (wherein it is simulated that the rides were started at exactly the same point of time).

Alternatively or additionally, additional position data (for instance calculated from additional data provided by an additional GPS receiver of an additional video camera of an additional user) can be integrated into the recorded (video) image data which will indicate where exactly the bicycle is located—during another, simultaneous, later or earlier ride of the additional user—on the distance 17 ridden/in the course 17.

Thereby, the user and the additional user can compare their rides performed through the same course 17 with each other (wherein it is simulated that the rides were started at exactly the same point of time).

The position data 14 of the user and the additional position data of the additional user can for instance be characterized by means of symbols indicated in different colors.

Alternatively or additionally, segments of the distance 17 ridden/or of the ridden course 17 can be represented in respectively different colors, wherein the coloring of a segment can be dependent on the speed in the respective segment, in particular on the average speed.

Alternatively or additionally, data provided by the above-mentioned GPS receiver 4 and/or by the speed or acceleration measuring device and indicating the respective speed/average speed for each of the above-mentioned segments can be integrated into the recorded (video) image data.

As a further example, in FIG. 5 there is shown an exemplary representation of data displayed after the integration of additional image data/“skin” image data into video image data recorded during skiing.

As becomes obvious from FIG. 5, into the (video) image data 29 recorded by the video camera 2 during skiing additional data are integrated with the aid of a corresponding set of “skin” image data, which, for instance, represent a measuring device 27.

As will also become obvious from FIG. 5, additionally the data provided by the above-mentioned GPS receiver 4, and/or the speed or acceleration measuring device, and/or the temperature measuring device, and/or the time measuring device, and/or by the above-mentioned further measuring devices, e.g. the heart rate measuring device and/or the barometric altitude measuring device and/or the data determined therefrom will be integrated into the recorded (video) image data in such a manner that they will be indicated by the measuring device 27 which is contained in the “skin” image data when viewing the generated image data.

In an advantageous variant of the data communication system 1, the user can select which data exactly (i.e., which of the data provided by the GPS receiver 4, and/or the speed or acceleration measuring device, and/or the temperature measuring device, and/or the time measuring device, and/or the above-mentioned further measuring devices, as for instance the heart rate measuring device and/or the barometric altitude measuring device—e.g. corresponding speed and time measurement data, but not corresponding temperature data, etc., etc.) shall be displayed together with a certain set of “skin” image data or shall be integrated into the corresponding (video) image data.

In an advantageous variant of the data communication system 1, the user himself or herself can co-design or co-adapt the exact appearance of a set of “skin” image data.

By way of example, in the “skin” image data shown in FIG. 2 the user himself/herself could determine whether and which of the outside mirrors 7a, 7b shall be displayed (or which form and/or size these outside mirrors should definitely have), and/or their position, and/or the position or the appearance of the instrument panel 8 (or which form and/or size the instrument panel shall definitely have), and/or the position and/or the form and/or the size of further elements to be displayed (or optionally not to be displayed) which are contained in the respective “skin” image data,—e.g. of a map, e.g. of a Google® map, etc., etc.

Alternatively or additionally, the user can for instance select or design himself/herself or adapt the respective color(s) and/or the definitely used color combination of a set of “skin” image data, and/or the scale of the above-mentioned map, in particular of the Google® map, etc., etc.

Alternatively or additionally, the scale of the above-mentioned map can also be adapted automatically, e.g. according to the respective speed, or in any other manner.

Alternatively or additionally, the user can optionally integrate a text field editable by him/her at will into the “skin” image data and can use said text field e.g. as a name plate—indicating his/her name—and/or as a title label—indicating a video title chosen by him/her—, etc., etc.

In a further variant, instead of the computer 5 or the server 6, for the generation of the above-mentioned (edited) (video) data there can also be used any other device, e.g. the above-mentioned mobile phone of the user which can be connected to the video camera 2 in a wire-bound or wireless manner, as explained above, for instance by means of Bluetooth, or e.g. the video camera 2 itself, etc.

When for the editing of the image data recorded by the video camera 2 the video camera 2 itself or for instance the above-mentioned mobile phone is used, prior thereto the corresponding above-mentioned further image data (“skin” image data) which are intended for the editing will be transmitted to the video camera 2 or to the mobile phone (e.g. from the server 6 or from the computer 5).

The editing is carried out in a manner correspondingly similar or identical to the one used for the editing by the computer/server 5, 6 which has already been mentioned briefly above and will be explained in more detail below (for instance by using the above-mentioned (remote) control device of the video camera).

The respectively generated and edited (video) image data which are stored in the computer 5 or in the server 6 or in the mobile phone or in the video camera 2, etc. (and into which, as explained above, corresponding data provided by the GPS receiver 4, and/or the speed or acceleration measuring device, and/or the temperature measuring device, and/or the time measuring device, and/or the above-mentioned further measuring devices, or data obtained therefrom and/or the above-mentioned additional image data (“skin” image data) are integrated) can be released or unlocked by the respective user so that they can be viewed by one or several other users of the central server 6, for instance.

Alternatively or additionally, the respective user can send the generated data which are stored in the computer 5 or in the server 6 or in the mobile phone, etc., for instance by e-mail (e.g. directly from the server 6 or from his/her computer 5, or e.g. from his/her computer 5 by way of interconnection of the server 6, or e.g. from the server 6 by way of interconnection of his/her computer 5, or in any other manner).

Alternatively or additionally, the respective user can put the generated data which are stored in the computer 5 or in the server 6 or in the mobile phone, etc., on the Internet, e.g. at an Internet platform such as Youtube® (http://www.youtube.com), etc.

The generated image data edited in the above-explained manner can then be transmitted from the computer 5 or the server 6 or the mobile phone, etc., via the Internet to a corresponding computer/server 66 of the respective Internet platform and can be stored therein, as is illustrated in FIG. 1.

Alternatively or additionally, the respective user can have the generated and edited (video image) data which are stored in the computer 5 or the server 6 or in the mobile phone or in the video camera 2, etc. (and/or the above-mentioned unedited and/or only partially edited (video image) data) also displayed in his/her Twitter account; or in the respective Twitter account—as therein generally only text data, e.g. a maximum of 140 characters, can be displayed—there can be indicated only the indication that for the respective user new video image data have been provided (which can be viewed by other users) and/or an indication to the link/the data path where exactly said video image data can be retrieved, etc.

Instead of a direct indication to the link/data path where the video image data are stored, the text indication data indicated in the Twitter account can for instance also contain a link to a personal website of the user on which the video image data as well as also further data, e.g. Google® maps, are to be seen.

The above-mentioned text indication data indicated in the Twitter account (e.g. “new video with a maximum speed of 145 km/h during skiing in Hintertux: www.youtube.com/GHFRF”) can be displayed in the Twitter account allocated to the user for instance automatically after a (manual or automatic) upload of new video image data of the respective user e.g. on the server 6, the server 66, etc., i.e. a corresponding Twitter update can be carried out automatically in the respective Twitter account.

The text indication data can contain corresponding data provided by the GPS receiver 4, and/or the speed or acceleration measuring device, and/or the temperature measuring device, and/or the time measuring device, and/or the above-mentioned further measuring devices or data obtained therefrom.

In FIGS. 6a-6f there is shown an exemplary representation of data respectively displayed on a display device of the computer 5—shown in FIG. 1—of a user, as an explanation of method steps exemplarily carried out during the editing of the recorded video image data.

After the connection (as explained above, in a wireless or in a wire-bound manner) of the video camera 2 of the user to his/her computer 5 (PC/notebook/laptop/netbook/telephone or mobile phone with computer functions, etc.), there can be displayed—controlled by the above-mentioned software loaded on the computer 5—on its display device 105, e.g. a corresponding monitor/screen/display, which one of several, successively performed method steps is carried out at the moment in the editing of recorded video image data.

For instance, as is depicted in FIG. 6a, it is displayed by the display device 105 that at the moment a step “Select” 106a is carried out in which, among several sets of video image data stored on the above-mentioned storage medium 3 or on the above-mentioned further/separate storage medium etc. of the video camera 2 (and/or on the computer 5 or on the server 6) and to be edited, the user can select that set of video image data which shall be edited next.

For this purpose, a video image data list 107 is displayed on the display device 105 which can indicate (all) video image data sets stored on the respective storage medium etc. or the respective file names thereof, or which can display the individual preview images for each of the video image data sets.

In order to facilitate the selection of a respective set of video image data, the user can play the respective video or parts thereof, i.e. the corresponding moving images can be presented in a corresponding window on the display device 105.

When the user has selected a corresponding set of video image data for the editing (e.g. by clicking on a respective icon of the above-mentioned video image data list 107), then, as is shown in FIG. 6b and is indicated by the display device 105, a step “Cut” 106b can be carried out.

Here the selected set of video image data can be highlighted in the video image data list 107, as is shown in FIG. 6b, and can be played in form of a corresponding video in a window 108 represented by the display device.

Then, the user can cut the selected set of video image data correspondingly, in particular by means of corresponding buttons 109 which can be slidably operated by the user, by means of which the starting point 109a and the final point 109b of the set of video image data can be determined (image data lying in time before the chosen starting point 109a and after the chosen final point 109b will then be cut out of the set of video image data).

After the cutting of the selected set of video image data, a step “SelectSkin” 106c can be carried out, as is shown in FIG. 6c and is indicated by the display device 105.

In connection therewith, the user can select that set of skin image data among several sets of skin image data stored on the computer 5 which shall be used for the editing of the selected set of video image data.

In order to facilitate the selection of a respective set of skin image data by the user, the images which correspond to a respective set of skin image data can be represented respectively in a corresponding window 110 on the display device 105.

A set of skin image data preceding the set of skin image data depicted respectively at the moment will then be represented in the window 110 when the user operates a corresponding button 110a.

Correspondingly, a set of skin image data following the set of skin image data depicted respectively at the moment will be shown in the window 110 when the user operates a corresponding further button 110b.

If the user wants to view/download/select further sets of skin image data—in particular sets of skin image data momentarily not stored on the user's computer 5, but on the above-mentioned server 6—the user can operate an additional button 111 (“more skins”).

A part of the sets of skin image data stored on the above-mentioned server 6 may be blocked for certain users or may only be released for certain users for viewing/downloading/selecting.

The users for whom these sets of skin image data are released can, for instance, be selected “manually” by one or several administrators of the server 6—for instance corresponding sponsors—, or they can be selected automatically according to certain criteria (assessment of a user by other users, or status of the user, by kilometers/meters in altitude covered by the user, the maximum speed achieved by the user, or by a proof furnished by the user by means of the above-mentioned data that he/she was at a certain place at a certain time (at which for instance an event of the above-mentioned sponsors took place), etc., etc.).

As is shown in FIG. 6d and is displayed by the display device 105, after the selection of a skin (see the step shown in FIG. 6c) a step “Download Skin” 106d can be carried out.

In this connection, first of all a selection can be carried out with respect to the fact to which category a set of skin image data to be viewed/downloaded shall belong, e.g. to which of the above-mentioned kinds of activities/sports (e.g. skiing, snowboarding, bicycling, in particular mountain biking, surfing, waterskiing, driving a motor boat, sailing, driving a car, motorcycling, flying, parachuting, paragliding, hang-gliding, etc.).

For this purpose, a skin category list 112 will be displayed on the display device 105 which indicates (all) possible ones of the above-mentioned categories/kinds of sport.

When the user has selected a corresponding skin category (e.g. by clicking on a respective icon of the above-indicated skin category list 112), images corresponding to a set of skin image data belonging to the respective category can be represented in a corresponding window 110 on the display device 105, as is shown in FIG. 6d.

In this connection, the corresponding set of skin image data can be transmitted via the Internet from the server 6 to the computer 5—as it is not stored on the computer 5 of the user.

A set of skin image data of the respectively selected category, stored on the server 6 and preceding the set of skin image data depicted respectively at the moment, will be represented in the window 110, when the user operates a corresponding button 110a.

Correspondingly, a set of skin image data stored on the server 6 and following the set of skin image data represented respectively at the moment will be represented in the window 110, when the user operates a corresponding further button 110b.

When a “Save” button 112 is operated, the respective set of skin image data represented in the window 110 will be downloaded from the server 6 and will be saved/stored locally and permanently in the computer 5.

When, at a later point of time, the step “Select Skin” 106c, explained above and shown in FIG. 6c, will be carried out once again, the then locally stored set of skin image data downloaded from the server 6 will be available locally on the computer 5, i.e. it can be selected by the user directly in the step “Select Skin” 106c, which is represented in FIG. 6c, for the editing of a respective set of video image data.

When (prior to or after a corresponding editing, in particular prior to or after the integration of corresponding skin image data) a corresponding set of video image data shall be put on the Internet, e.g. at Youtube® (http://www.youtube.com) or at Vimeo® (http://www.vimeo.com), etc., then the step “Upload” 106e, which is shown in FIG. 6e, can be carried out.

The set of video image data to be uploaded respectively can be selected by clicking on a respective icon of the above-mentioned video image data list 107; the corresponding log-in data for Youtube, Vimeo, etc., can be entered into a window 113 and can be stored on the above-mentioned server 6 by allocating them to the respective user (so that on the occasion of the next usage of the server 6 by the user, a separate entering of the Youtube or Vimeo log-in data in the above-mentioned window 113 can be unnecessary; instead thereof, for the log-in at Youtube/Vimeo, etc., the log-in data deposited on the server 6 can be used automatically).

After the performance of a log-in at Youtube/Vimeo etc. under the control of the server 6 and/or the computer 5, the above-mentioned selected sets of video image data can be transmitted via the Internet to the computer/server 66 (shown in FIG. 1) of the respective Internet platform, and can be saved/stored thereat.

If video image data edited in the above explained manner and underlaid with or to be underlaid with skin image data shall be compressed or shall be brought into a corresponding standard format or shall be saved, the step “Save” 106f, which is illustrated in FIG. 6f, can be carried out.

The set of video image data to be stored respectively can be selected by clicking on a respective icon of the above-mentioned video image data list 107.

As is shown in FIG. 6f, in a window 114 a preview of the set of video image data to be compressed/to be formatted/to be saved/stored and already underlaid with skin image data or to be underlaid with skin image data can be displayed, and in a window bar 115 the progress of the process of compression/formatting/saving, etc. can be displayed.

In a further variant, during viewing an edited set of video image data, a respective user can switch to and fro between different skin image data to be used (with which the unedited video image data are underlaid), for instance by clicking on a corresponding switching button.

In an additional variant, a user can superimpose or overlay two different sets of video image data (or corresponding parts thereof) respectively underlaid with skin image data or to be underlaid with skin image data, or can superimpose or overlay two sets of video image data and can then underlay them with corresponding skin image data. Advantageously, this is carried out by means of correspondingly similar sets of video image data, for instance with respect to the same ski run, e.g. the Streif run in Kitzbiihel, recorded at different times and, if applicable, by different users.

1. A data communication method, comprising:
(a) providing image data recorded by a video camera;
(b) integrating additional image data into the image data recorded by the video camera.

2. The data communication method according to claim 1, further comprising in addition to or instead of integrating additional image data:
integrating data obtained by a measuring device or produced therefrom into the image data recorded by the video camera.

3. The data communication method according to claim 2, wherein the measuring device is a GPS receiver or comprises a GPS receiver.

4. The data communication method according to claim 2, wherein the measuring device is or comprises a speed or acceleration measuring device and/or a temperature measuring device and/or a time measuring device and/or a heart rate measuring device and/or a barometric altitude measuring device.

5. A GPS and/or video data communication system, comprising:
a device for the integration of additional image data into image data recorded by a video camera.

6. The GPS and/or video data communication system according to claim 5, wherein the device is or comprises a computer and/or a server.

7. The GPS and/or video data communication system according to claim 5, which additionally comprises a device for the integration of data obtained by a measuring device or produced therefrom into the image data recorded by the video camera.

8. The GPS and/or video data communication system, comprising means to,
(a) provide image data recorded by a video camera; and
(b) integrate additional image data into the image data recorded by the video camera.

9. A device, which is designed and adapted such that it can be used in a system as a device for the integration of additional image data into image data recorded by a video camera.

10. A device, which is designed and adapted such that it can be used in a system as a device for the integration of data obtained by a measuring device or produced therefrom into image data recorded by a video camera.
